(19) United States
(12) Patent Application Publication
(10) Pub. No.: US 2026/0168628 A1
(43) Pub. Date: Jun. 18, 2026

(54) PROPANE TANK COVER APPARATUS FOR COVERING A MULTI-TANK SUBASSEMBLY

(71) Applicant: YSN Imports, LLC, Commerce, CA (US)

(72) Inventor: Yisroel Schochet, Los Angeles, CA (US)

(21) Appl. No.: 19/124,807

(22) PCT Filed: Oct. 24, 2023
(86) PCT No.: PCT/US2023/035805

§ 371 Date: Apr. 25, 2025

Related U.S. Application Data
(60) Provisional application No. 63/419,267, filed on Oct. 25, 2022.

(51) Int. Cl. F17C 13/08

(52) U.S. Cl. CPC F17C 13/084; F17C 2205/0111; F17C 2205/0115; F17C 2205/013; F17C 2221/035; F17C 2223/0153; F17C 2223/033; F17C 2270/0745

(57) ABSTRACT

A propane tank cover apparatus for covering a multi-tank subassembly with adjustable regulator is disclosed. A main housing defines a tank cavity configured to house the multi-tank subassembly. The housing has a bottom side and a top side disposed oppositely of one another, and a forward face and a rearward face disposed oppositely of one another. A regulator port extends through the forward face. A regulator port cap is configured to removably cover the regulator port and be locked thereat. The housing has a pair of tank valve ports. A pair of tank port caps are configured to removably cover a respective tank valve port and be locked thereat. The housing may be formed of housing halves removably fastened to one another. The regulator port cap and tank port cap may each have a grip feature to facilitate manual rotation the caps into and out of covered and locked configuration.

### RELATED APPLICATIONS

This application claims the benefit of U.S. Provisional Application No. 63/419,267 filed Oct. 25, 2022, the content of which is incorporated by this reference in its entirety for all purposes as if fully set forth herein.

### TECHNICAL FIELD

The present disclosure relates to protective covers for propane tanks.

### SUMMARY

Certain deficiencies of the prior art are overcome by the provision of a propane tank cover apparatus for covering a multi-tank subassembly having an adjustable regulator, as disclosed herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic perspective view of one non-limiting example of a propane tank cover apparatus for covering a multi-tank subassembly having an adjustable regulator;

FIG. 2 is a further diagrammatic perspective view of the example apparatus of FIG. 1;

FIG. 3A is a magnified view of detail 3A in FIG. 2;

FIG. 3B is a magnified view of detail 3B in FIG. 2;

FIG. 4 is a front view of a prior art multi-tank subassembly having an adjustable regulator, wherein the propane tanks are standard 20 lb. size;

FIG. 5 is a diagrammatic front view of the example apparatus in FIG. 1;

FIG. 6 is a diagrammatic side view of the example apparatus in FIG. 1;

FIG. 7 is a diagrammatic top view of the example apparatus in FIG. 1;

FIG. 8 is a diagrammatic bottom view of the example apparatus in FIG. 1;

FIG. 9 is a diagrammatic front view similar to that of FIG. 5, but wherein the tank cavity is housing a multi-tank subassembly with an adjustable regulator, and the regulator port cap is removed to provide access to the regular through the housing;

FIG. 10 is a diagrammatic top view similar to that of FIG. 7, but wherein the tank cavity is housing a multi-tank subassembly with an adjustable regulator, and the tank port caps are removed to provide access to the tank valves of respective propane tanks;

FIG. 11 is a diagrammatic bottom view similar to that of FIG. 8, but wherein the tank cavity is housing a multi-tank subassembly with an adjustable regulator, and the mounting base of the subassembly is viable through the open bottom side of the apparatus;

FIG. 12 is a diagrammatic perspective view similar to that of FIG. 1, but wherein the tank cavity is housing a multi-tank subassembly with an adjustable regulator, and the regulator port caps and tank port caps are shown having been unlocked and removed from covered engagement of their respective ports;

FIG. 13 is a diagrammatic perspective view of an example port cap (regulator port cap or tank port cap);

FIG. 14 is a magnified view of detail 14 in FIG. 12;

FIG. 15 is a magnified view of detail 15 in FIG. 12;

FIG. 16 is a diagrammatic perspective exploded view of the example apparatus and multi-tank subassembly of FIG. 12 with all of the port caps removed, and illustrating a pair of identical housing halves configured to be fastened together to form the main housing;

FIG. 17 is a diagrammatic perspective exploded view similar to that of FIG. 16, but wherein the apparats and multi-tank subassembly are shown from a reverse direction;

FIG. 18 is a diagrammatic cross-section view taken along lines 18-18 in FIG. 7, but with an example multi-tank subassembly shown positioned within the tank cavity;

FIG. 19 is a diagrammatic cross-section view taken along lines 19-19 in FIG. 7, but with an example multi-tank subassembly shown positioned within the tank cavity; and

FIG. 20 is a diagrammatic perspective view similar to that of FIG. 1, but wherein the apparatus is an alternate embodiment which has a greater height to accommodate taller propane tanks.

### DETAILED DESCRIPTION OF THE PREFERRED EMBODIMENTS

Referring now to the drawings, like reference numerals designate identical or corresponding features throughout the several views.

Certain example embodiments of a propane tank cover apparatus for covering a multi-tank subassembly having an adjustable regulator are shown generally at 100.

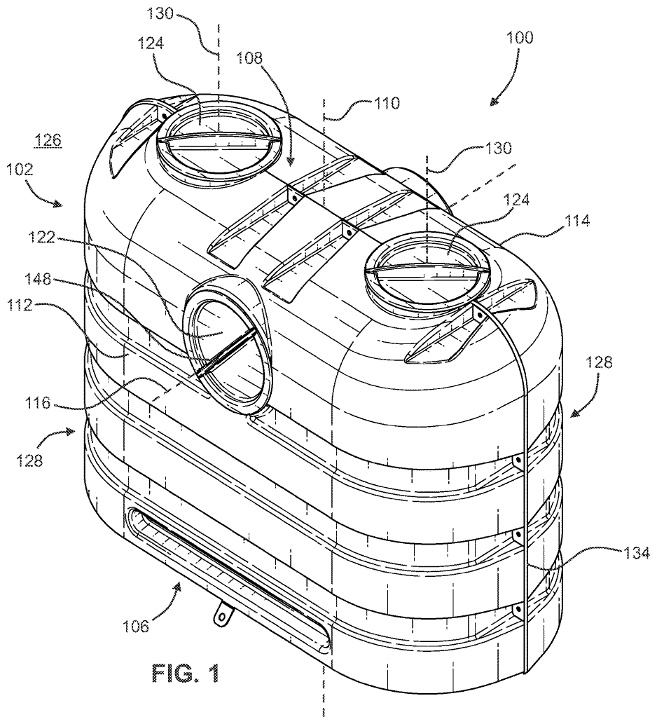

Referring to FIG. 1, a propane tank cover apparatus 100 may comprise a main housing 102 and at least one regulator port cap 122.

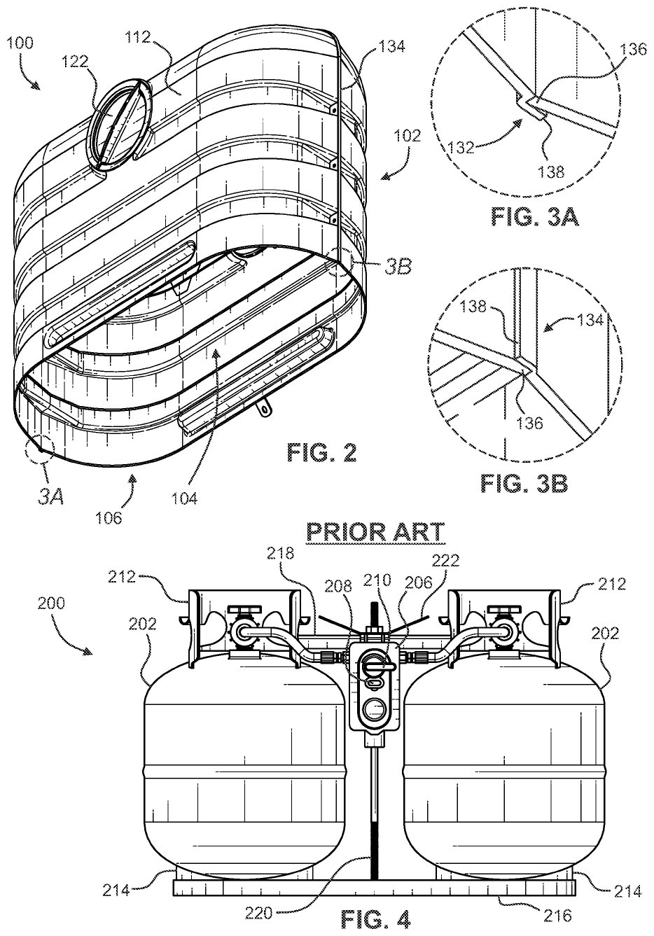

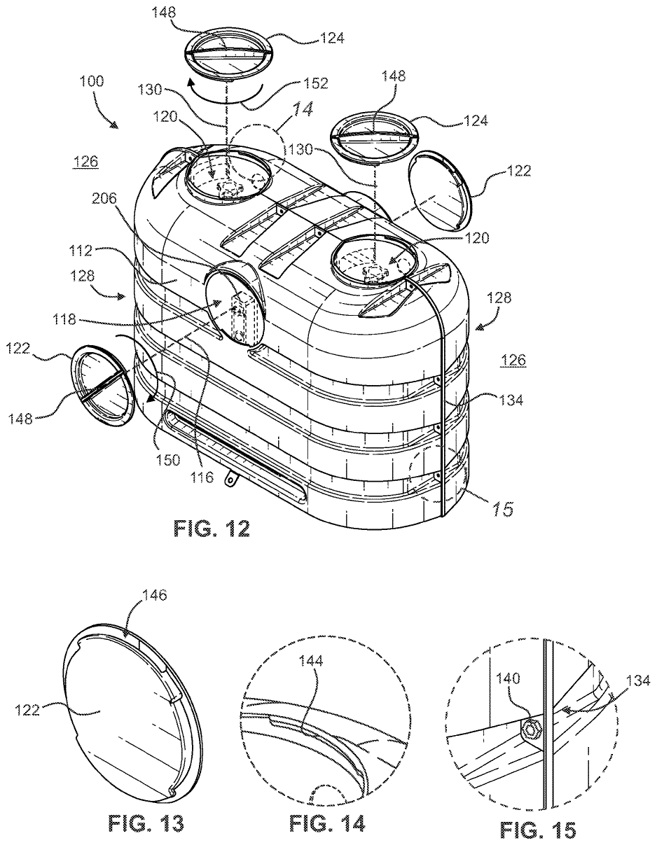

Referring to FIGS. 1, 2 and 18, the main housing 102 may define a tank cavity 104 configured to house a multi-tank subassembly therein, such as the conventional multi-tank subassembly 200 shown in FIG. 4. The main housing 102 may have a bottom side 106 and a top side 108 disposed oppositely of one another along a main vertical axis 110. Referring to FIGS. 1 and 19, the main housing 102 may include a forward face 112 and a rearward face 114 disposed oppositely of one another along a regulator display axis 116. The regulator display axis 116 may preferably be orthogonal to the main vertical axis 110. Referring to FIGS. 9 and 12, a regulator port 118 may extend through the forward face 112 along the regulator display axis 116.

Referring to FIGS. 1 and 12, the regulator port cap 122 may be configured to be placed in and removed from covering engagement with the regulator port 118.

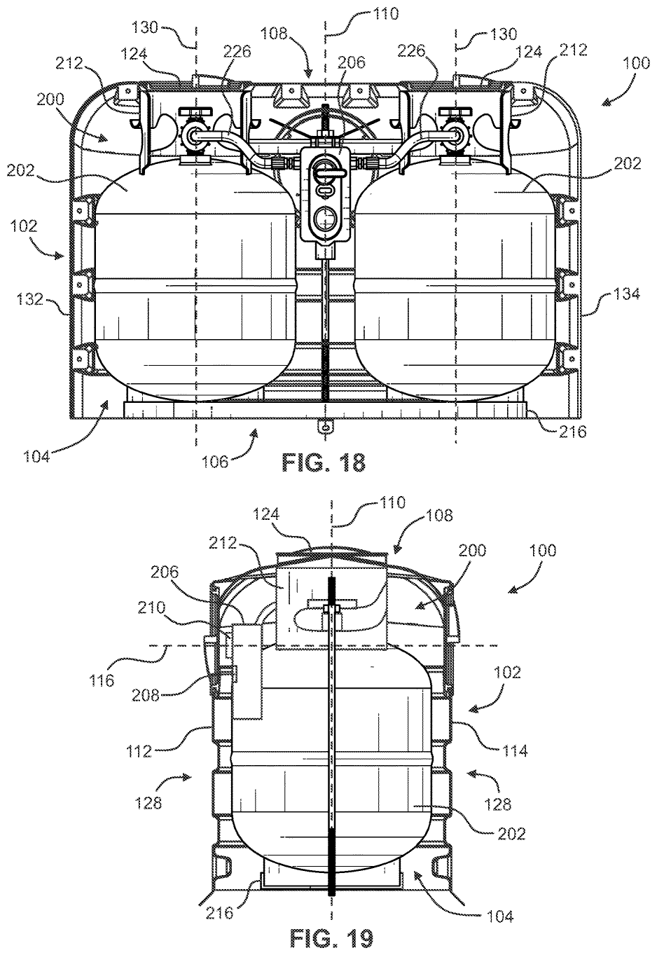

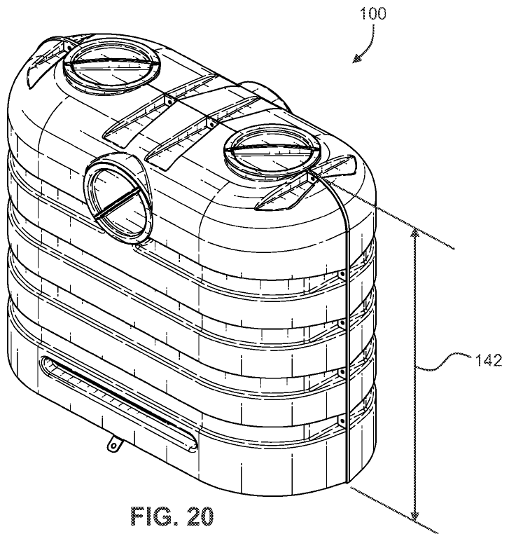

Referring to FIGS. 1, 12 and 18, a pair of tank alignment axes 130 may be defined in parallel with and on opposing sides of the main vertical axis 110. Generally, the tank alignment axes 130 would be designed to align with the vertical axes of the propane tanks in the respective multi-tank subassembly 200 (see, e.g., FIG. 18). The main housing 10 may have a pair of tank valve ports 120, each extending through the top side 108 along a respective tank alignment axis 130. The apparatus 100 may further comprise a pair of tank port caps 124, each of which is configured to be placed in and removed from covering engagement with a respective said tank valve port 120.

Referring to FIGS. 1, 16 and 17, the main housing 102 may preferably be formed of a pair of housing halves 128 configured to be fastened to one another. Such fastening may be by way of fasteners 140, such as bolt/nut pairs or the like (see, e.g., FIG. 15). The housing halves 128 may preferably be identical to one another, and may be molded from the same tooling. One of the housing halves 128 may be defined as comprising the forward face 112 of the main housing 102 and the other housing half 128 may be defined as comprising the rearward face 114 of the main housing 102. The housing halves 128 may preferably be manufactured by way of injection molding, and may be comprised of heavy-duty polypropylene or the like.

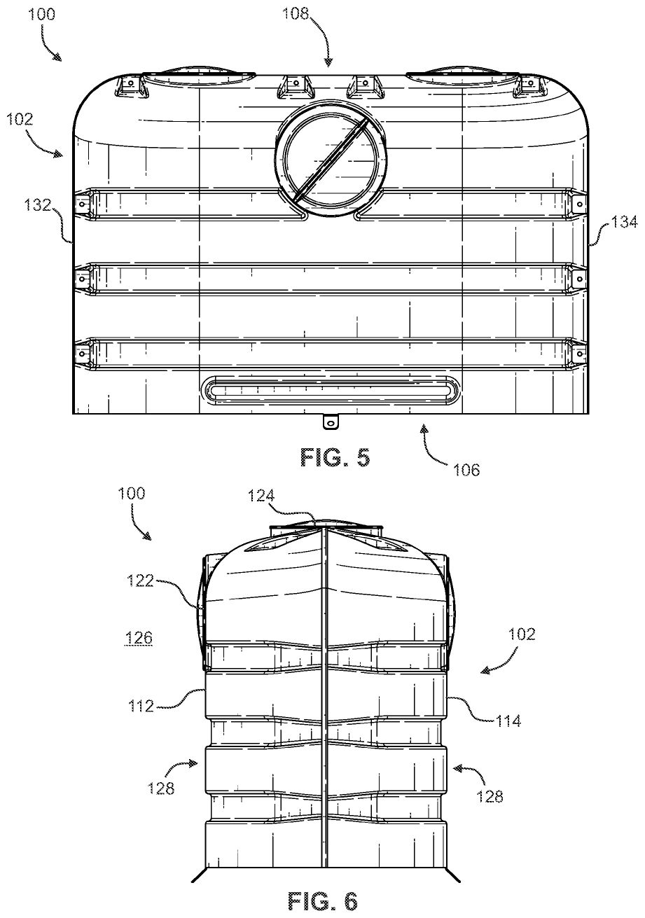

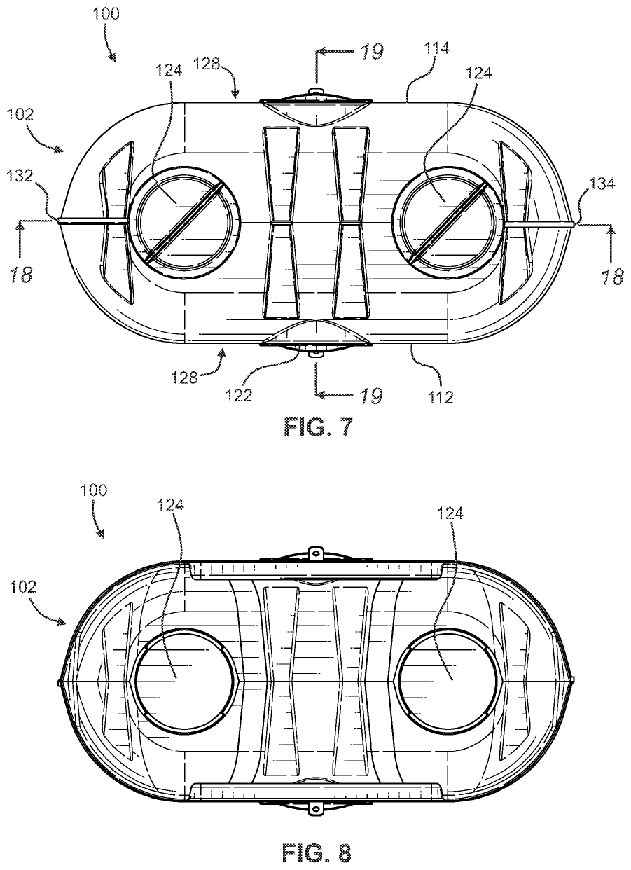

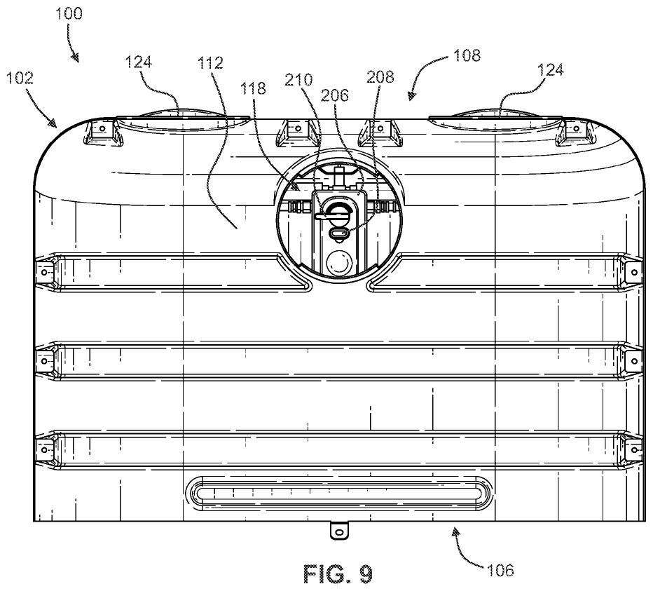

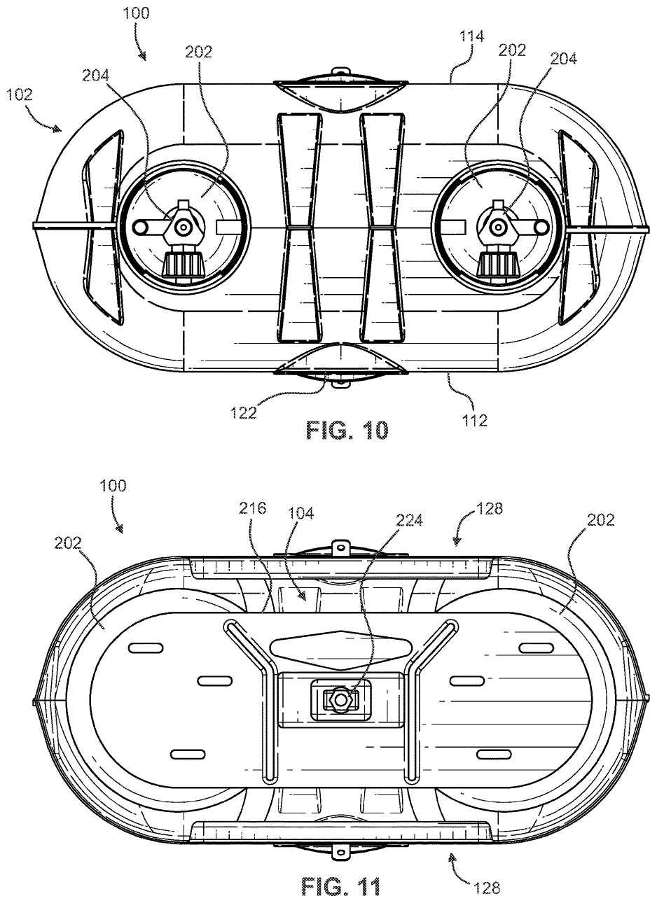

Referring to FIGS. 5 and 7, the main housing 102 may have a first lateral interface edge 132 and a second lateral interface edge 134 disposed oppositely of one another. Referring to FIGS. 1 and 18, the main vertical axis 110 and the regulator display axis 116 may preferably be disposed equidistant from the first lateral interface edge 132 and the second lateral interface edge 134. As illustrated in FIG. 9, this configuration helps ensure that the regulator 206 disposed between dual propane tanks 202, including any indicators 208 and actuatable controls 210 located on the regulator 206, are easily visually and manually accessible by the user through the open regulator access port 118 in the forward face 112.

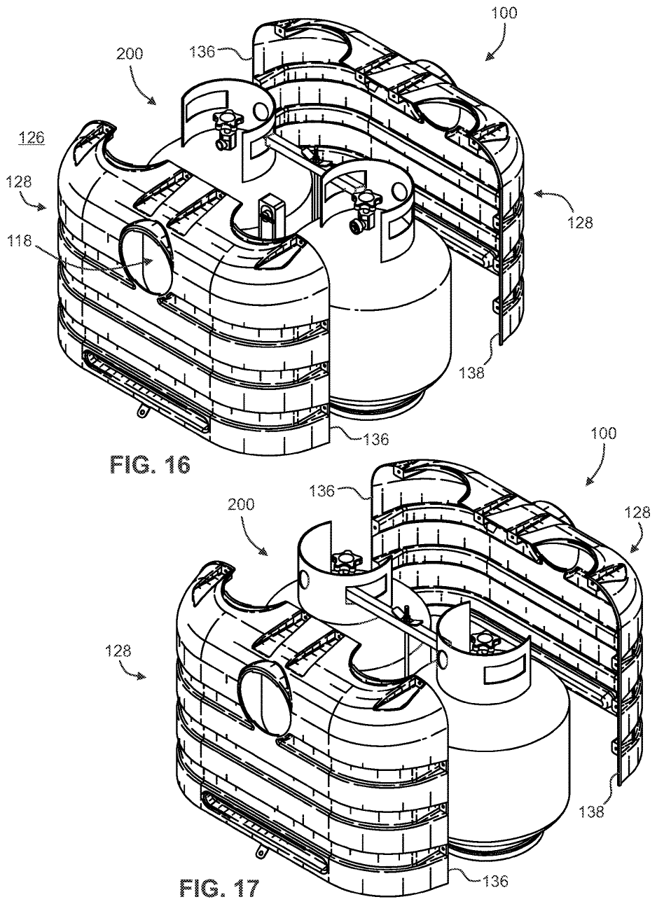

Referring to FIGS. 16 and 17, each of the housing halves 128 may have a first lateral terminal edge 136 and a second lateral terminal edge 138. In such case, when the pair of housing halves 128 are fastened to one another, the first lateral interface edge 132 and the second lateral interface edge 134 may each be defined by an overlapped engagement of a respective said first lateral terminal edge 136 with a respective said second lateral terminal edge 138 (see, e.g., FIGS. 3A and 3B).

Referring to FIGS. 1 and 12, the regulator port cap 122 may be configured to be locked into the covering engagement with the regulator port 118 by rotation of the regulator port cap 122 in a first direction 150 about the regulator display axis 116, and unlocked from the covering engagement with the regulator port 118 by rotation of the regulator port cap 122 oppositely of the first direction 150. Similarly, each of the tank port caps 124 may be configured to be locked into the covering engagement with the respective tank valve port 120 by rotation of the tank port cap 124 in a second direction 152 about the respective tank alignment axis 130, unlocked from the covering engagement with the respective tank valve port 120 by rotation of the tank port cap 124 oppositely of the second direction 152.

Referring to FIGS. 12-14, the locking of the port caps (122, 124) to their respective access ports (118, 120) may be by way of a tongue-and-groove engagement. For example, referring to FIG. 13, the port cap may include a radially-disposed lock lip groove 146, and the corresponding access port may include a radially-disposed lock lip 144 configured to be lockingly received by the lock lip groove 146 when the port cap is rotated in one direction (e.g., clockwise). The regulator port cap 122 and the tank port cap 124 may each have a cap grip feature 148 to facilitate a user's ability to hold the caps and manually twist/rotate the caps into and out of their locked configuration.

The following listing matches certain terminology used within this disclosure with corresponding reference numbers used in the non-limiting examples illustrated in the several figures.

| | |
|---|---|
| 100 | propane tank cover apparatus |
| 102 | main housing |
| 104 | tank cavity |
| 106 | bottom side |
| 108 | top side |
| 110 | main vertical axis |
| 112 | forward face |
| 114 | rearward face |
| 116 | regulator display axis |
| 118 | regulator port |
| 120 | tank valve port |
| 122 | regulator port cap (e.g., twist-lock) |
| 124 | tank port cap (e.g., twist-lock) |
| 126 | ambient environment (i.e., external to the main housing) |
| 128 | housing half (e.g., molded from heavy-duty polypropylene) |
| 130 | tank alignment axis |
| 132 | first lateral interface edge |
| 134 | second lateral interface edge |
| 136 | first lateral terminal edge |
| 138 | second lateral terminal edge |
| 140 | fastener (e.g. bolt or rivet) |
| 142 | cover height |
| 144 | lock lip |
| 146 | lock lip groove |
| 148 | cap grip |
| 150 | first rotation direction (of regulator port cap) |
| 152 | second rotation direction (of tank port cap) |
| 200 | multi-tank subassembly |
| 202 | propane tank |
| 204 | tank valve |
| 206 | regulator (e.g., adjustable auto-regulator) |
| 208 | indicator (e.g., level indicator) |
| 210 | actuatable control (e.g., tank selector switch) |
| 212 | tank handle |
| 214 | tank foot |
| 216 | mounting base |
| 218 | cross bar |
| 220 | mounting securement rod |
| 222 | wingnut |
| 224 | base nut |
| 226 | pigtail hose connector |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A propane tank cover apparatus for covering a multi-tank subassembly having an adjustable regulator, the apparatus comprising:
a main housing defining a tank cavity configured to house the multi-tank subassembly therein, the main housing having a bottom side and a top side disposed oppositely of one another along a main vertical axis, and a forward face and a rearward face disposed oppositely of one another along a regulator display axis, the regulator display axis being orthogonal to the main vertical axis, a regulator port extending through the forward face along the regulator display axis; and
a regulator port cap configured to be placed in and removed from covering engagement with the regulator port.

2. The apparatus of claim 1, wherein
(a) a pair of tank alignment axes are defined in parallel with and on opposing sides of the main vertical axis;
(b) the main housing has a pair of tank valve ports, each tank valve port extending through the top side along a respective said tank alignment axis; and
(c) the apparatus further comprises a pair of tank port caps, each tank port cap being configured to be placed in and removed from covering engagement with a respective said tank valve port.

3. The apparatus of claim 2, wherein the main housing is formed of a pair of housing halves configured to be fastened to one another, the housing halves being identical to one another, one of the housing halves comprising the forward face and the other housing half comprising the rearward face.

4. The apparatus of claim 3, wherein
(a) the main housing has a first lateral interface edge and a second lateral interface edge disposed oppositely of one another; and
(b) the main vertical axis and the regulator display axis are disposed equidistant from the first lateral interface edge and the second lateral interface edge.

5. The apparatus of claim 4, wherein
(a) each of the housing halves has a first lateral terminal edge and a second lateral terminal edge; and
(b) when the pair of housing halves are fastened to one another, the first lateral interface edge and the second lateral interface edge are each defined by an overlapped engagement of a respective said first lateral terminal edge with a respective said second lateral terminal edge.

6. The apparatus of claim 2, wherein
(a) the regulator port cap is configured to be
(i) locked into the covering engagement with the regulator port by rotation of the regulator port cap in a first direction about the regulator display axis; and
(ii) unlocked from the covering engagement with the regulator port by rotation of the regulator port cap oppositely of the first direction; and
(b) each of the tank port caps is configured to be
(i) locked into the covering engagement with the respective tank valve port by rotation of the tank port cap in a second direction about the respective tank alignment axis; and
(ii) unlocked from the covering engagement with the respective tank valve port by rotation of the tank port cap oppositely of the second direction.

7. The apparatus of claim 6, wherein the locking is by way of a tongue-and-groove engagement.
